(19) United States
(12) Patent Application Publication
(10) Pub. No.: US 2016/0132420 A1
(43) Pub. Date: May 12, 2016

(54) BACKUP METHOD, PRE-TESTING METHOD FOR ENVIRONMENT UPDATING AND SYSTEM THEREOF

(71) Applicant: INSTITUTE FOR INFORMATION INDUSTRY, TAIPEI CITY (TW)

(72) Inventors: CHIEN-TING KUO, TAICHUNG CITY (TW); SHIH-JEN CHEN, NEW TAIPEI CITY (TW)

(21) Appl. No.: 14/536,745

(22) Filed: Nov. 10, 2014

(51) Int. Cl. G06F 11/36; G06F 9/44

(52) U.S. Cl. CPC G06F 11/3684; G06F 11/3688; G06F 8/70

(57) ABSTRACT

A pre-testing method adapted for environment updating is illustrated. The pre-testing method comprises following steps: while detecting an environment updating process should be performed to an operating system environment, determining whether an environment test should be executed; while the environment test is executed, selecting a plurality of pieces of system and software information of the operating system environment, wherein the system and software information of the operating system environment is extracted from the operating system environment; generating a virtual machine having a first clone environment according to the system and software information; performing the environment updating process to the first clone environment so as to cause the first clone environment to become a second clone environment of the virtual machine; and executing the environment test for the second clone environment.

### BACKGROUND

1. Technical Field

The present disclosure relates to a backup method adapted to an operating system environment, in particular, to a pre-testing method adapted for environment updating and a system thereof using the backup method.

2. Description of Related Art

With the technology advancement, information industrial develops rapidly and widely. People in daily life usually use the computing device or the cloud server, and the computing device or the cloud server has an operating system environment, such that the user can operate the computing device or the cloud server through the operating system. However, when the user installs the new software in the operating system environment, the software patch (for updating the software), or the operating system patch (for updating the operating system) in the operating system environment, the incompatible problem or the program flaw may sometimes occur, and thus an error may be generated in portion of softwares and the operating system itself, or the operating system environment is not secure which someone may hack easily.

To avoid the error generation due to the incompatible problem or the program flaw, further the security flaw problem of the portion of softwares and the operating system itself, a currently used manner is to entirely backup the operating system environment and the installed softwares in each step which the new software or the patch is installed in the operating system environment, such that when the error is generated in the portion of the softwares or the operating system itself, the backup data can be used to recover the operating system environment.

A system snapshot is a technology which can backup a system image of the whole operating system environment (comprising the software installed herein) and recover the operating system environment. However, when the backup number and the backup organization number increases, the system snapshot consumes a great quantity of the storage space.

Additionally, another currently used manner is that the user reports the information related to the software installation proceeding, software update proceeding operating system update proceeding, incompatible problem in the updated operating system environment, or security flaw problem in the updated operating system environment to the software company, and then the software company deals with the problems accordingly. However, the manner passively waits the problem to occur, and then integrates the related data but does not actively find the incompatible problem or the security flaw problem.

Regarding the information security check, the operating system environment or the software must be updated to maintain the information security and avoid the hidden risk of the information security. However, if the system snapshot is used to backup the system image periodically, or during the software installation, the software update, or the operating system environment update, the consumption of the storage space is increasing as time advances. If the compatibility, vulnerability, or efficiency is not tested, and the error is generated in the portion of the softwares or the operating system environment or the operating system environment is hacked easily, it may be convenient for the user to use the software or the operating system environment, and even cause the work stop.

In addition, if the computing devices or cloud servers must process the software installation, software update, or the operating system environment update, the management information system (MIS) engineer can understand whether the problem exists merely after each of the computing devices or cloud servers have finished the software installation, software update, or the operating system environment update. If the problem exists, the MIS engineer must recover the operating system environment by using the system image backup by the system snapshot, or report the related information to the corresponding software company to request the software company to deal with the problem. Thus, when the computing devices or cloud server must process the software installation, software update, or operating system environment update, the task of the software installation, software update, or operating system environment update is a heavy burden for the MIS engineer.

### SUMMARY

An exemplary embodiment of the present disclosure provides a pre-testing method adapted for environment updating. The pre-testing method comprises following steps: while detecting an environment updating process should be performed to an operating system environment, determining whether an environment t test should be executed; while the environment test is executed, selecting a plurality of pieces of system and software information of the operating system environment, wherein the system and software information of the operating system environment is extracted from the operating system environment; generating a virtual machine having a first clone environment according to the system and software information; performing the environment updating process to the first clone environment of the virtual machine so as to cause the first clone environment to become a second clone environment of the virtual machine; and executing the environment test for the second clone environment.

An exemplary embodiment of the present disclosure provides a pre-testing system adapted for environment updating. The pre-testing system comprises a computing device. While detecting that an environment updating process should be performed to an operating system environment, the computing device determines whether an environment test should be executed. While detecting that the environment test should be executed, the computing device selects a plurality of pieces of system and software information of the operating system environment, wherein the system and software information of the operating system environment is extracted from the operating system environment. The computing device generates a virtual machine having a first clone environment according to the system and software information. The computing device performs the environment updating process to the first clone environment of the virtual machine so as to cause the first clone environment to become a second clone environment of the virtual machine. The computing device executes the environment test for the second clone environment. According to a result of the environment test, the computing device determines whether the operating system environment can be performed with the environment updating process.

An exemplary embodiment of the present disclosure provides a pre-testing system adapted for environment updating. The pre-testing system comprises a cloud server system. While detecting that an environment updating process should be performed to an operating system environment, the cloud server system determines whether an environment test should be executed. While detecting that the environment test should be executed, the cloud server system selects a plurality of pieces of system and software information of the operating system environment operated in a first virtual machine of the cloud server system, wherein the system and software information of the operating system environment is extracted from the operating system environment. The cloud server system generates a second virtual machine having a first clone environment according to the system and software information. The cloud server system performs the environment updating process to the first clone environment of the second virtual machine to cause the first clone environment to become a second clone environment of the second virtual machine. The cloud server system executes the environment test for the second clone environment.

An exemplary embodiment of the present disclosure provides a pre-testing system adapted for environment updating. The pre-testing system comprises a computing device and a cloud server system. The cloud server system links o the computing device through an internet network. While detecting that an environment updating process should be performed to an operating system environment, the computing device or the cloud server system determines whether an environment test should be executed. While detecting that the environment test should be executed, the computing device selects a plurality of pieces of system and software information of the operating system environment and transmits to the cloud server system, wherein the system and software information of the operating system environment is extracted from the operating system environment. The cloud server system generates a virtual machine having a first clone environment according to the system and software information. The cloud server system performs the environment updating process to the first clone environment so as to cause the first clone environment to become a second clone environment of the virtual machine. The cloud server system executes the environment test for the second clone environment. According to a result of the environment test, the computing device determines whether the operating system environment can be performed with the environment updating process on the computing device.

An exemplary embodiment of the present disclosure provides a backup method adapted to an operating system environment. The backup method comprises following steps: extracting a plurality of pieces of system and software information of the operating system environment; and generating a virtual machine having a clone environment according to the system and software information.

To sum up, exemplary embodiments of the present disclosure provide a pre-testing system adapted for environment updating and a systems thereof, wherein the environment of the net software or the patch for the current operating system environment is pre-tested before the new software or the patch is installed in the operating system environment, such that the nuisance for recovering the operating system environment and the serious loss caused by that the operating system environment cannot be recovered can be avoided after the incompatible problem, the program flaw, the information security, or he bad efficiency occur. Furthermore, the backup method provided by the exemplary embodiment of the present disclosure can backup the current operating system environment merely according to the extracted system and software information of the operating system environment, which costs little storage space.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a flow chart of a pre-testing method for environment updating according to an exemplary embodiment of the present disclosure.

FIG. 2A is a block diagram of a computing device according to an exemplary embodiment of the present disclosure.

FIG. 2B is a block diagram of a cloud server system according to an exemplary embodiment of the present disclosure.

FIG. 3A and FIG. 3B are schematic diagrams of a pre-testing method for environment updating according to an exemplary embodiment of the present disclosure.

FIG. 4A and FIG. 4B are schematic diagrams of a pre-testing method for environment updating according to another exemplary embodiment of the present disclosure.

FIG. 5 is a schematic diagram of a pre-testing system for environment updating according to an exemplary embodiment of the present disclosure.

FIG. 6A and FIG. 6B are schematic diagrams of a pre-testing method for environment updating according to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

An exemplary embodiment of the present disclosure provides a pre-testing method for environment updating, and the pre-testing method for environment updating can automatically pre-test whether the updating problem, the program flaw,security flaw, or bad efficiency will exist between the operating system environment and the installed/uninstalled software if which the new software/patch is installed or the installed software is uninstalled in the current operating system environment. Since the operating system environment is pre-tested by the pre-testing method for environment updating, the MIS engineer can determine whether the operating system environment can be updated according to the result of the environment test. Thus, the consumption of the storage space for storing the backup can be reduced efficiently, and the burden for the MIS engineer to install the new software and the patch can be also reduced. Moreover, based upon the concept of the pre-testing method for environment updating, another exemplary embodiment of the present disclosure provides a pre-testing system for executing the pre-testing method for environment updating. Furthermore, the pre-testing method and system for environment updating use a backup method which costs little storage space. The backup method in an exemplary embodiment of the present disclosure merely stores the system and software information of the operating system environment rather than the system image of the whole operating system environment.

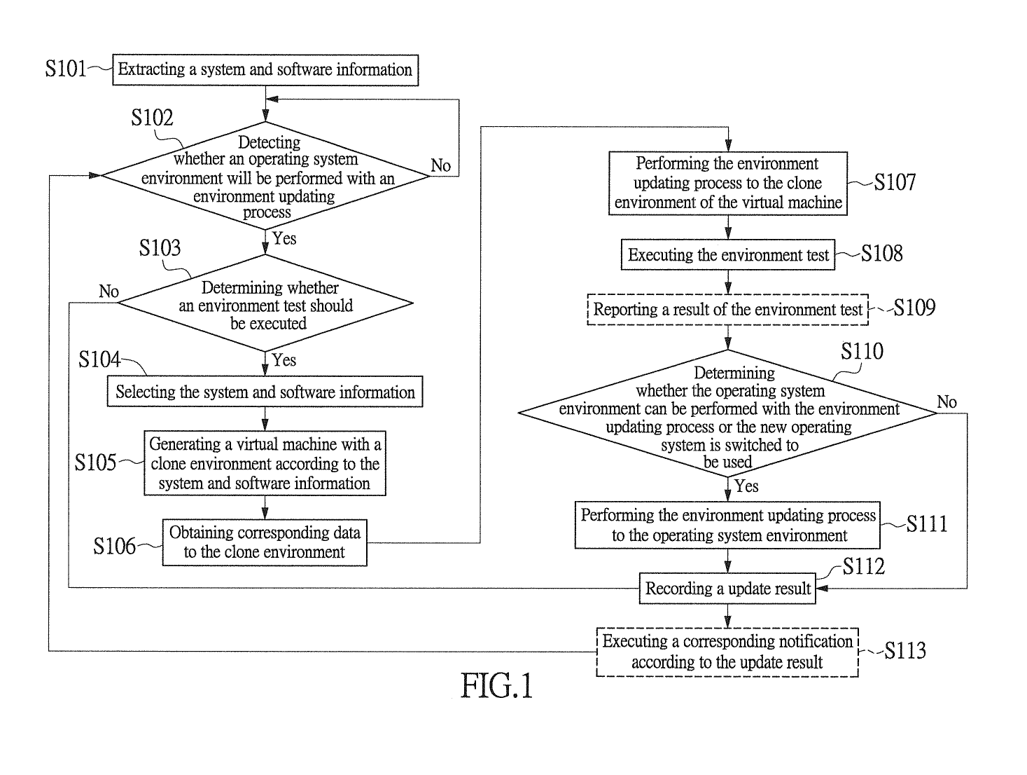

Referring to FIG. 1, FIG. 1 is a flow chart of a pre-testing method for environment updating according to an exemplary embodiment of the present disclosure. The pre-testing method for environment updating can be executed in a pre-testing system which can be simply implemented by a computing device or a cloud server system, or alternatively implemented by a system formed by the computing device and the cloud server system.

Firstly, at steps S101 the computing device or the low level monitoring operating system (i.e., hypervisor) of the cloud server system extracts a system and software information, wherein the system information of the system and software information is for example a system version, system serial code, or system setting configuration, and the software information of the system and software information is for example an application software name, application software version, application software setting, and other application software information. The computing device or the low level monitoring operating system of cloud server system uses a software agent, such as a parser, to extract the system and software information. Additionally, the present disclosure does not limit the type of the system and software information. In the exemplary embodiment, the system and software information can for example comprise at least one of an operating system version (such as Windows 7 or Android 4.1), an operating system environment related configuration (such as system setting, registry, registering code, or mobile device setting), an application software version (such as document edition software version or mobile device message software version), an application software setting (such as web browser or document edition software related setting) and an operating system environment and application software patch installation list. However, the present disclosure does not limit the implementation details of step S101.

In the exemplary embodiment, the computing device or the low level monitoring operating system of the cloud server system can be set to periodically extract the system and software information; or alternatively the computing device or the low level monitoring operating system of the cloud server system can extract the system and software information when the application software is initialized to install in the computing device or the virtual machine of the cloud server system, or alternatively, the computing device or the low level monitoring operating system of the cloud server system can extract the system and software information when a specific event happens during operation, such as the behavior of removing a software or modifying application software setting. In a word, when the computing device or the low level monitoring operating system of the cloud server system extracts the system and software information is not used to limit the present disclosure. For example, the system and software information could be extracted periodically; or alternatively, the system and software information could be extracted according to an operating command inputted by the MIS engineer.

Next, at step S102, the computing device or the low level monitoring operating system environment of the cloud server system detects whether an environment updating process will be performed to the operating system environment. For example, the environment updating process such as installing the patch of the software or the operating system patch to the operating system environment, installing the new software, uninstalling the installed software, or a plurality of different software are performed the process of updating, installing or uninstalling at the same time. If that the environment updating process will be performed in the operating system is detected, step S103 is then be executed; if that the environment updating process will be performed in the operating system is not detected, step S112 is then be executed. The computing device or the low level monitoring operating system of the cloud server system judges whether the user selects and clicks a specific file to execute the installation of the new software or the patch to detect whether the new software or the patch will be installed in the operating system; or alternatively, the computing device or the low level monitoring operating system of the cloud server system judges whether the computing device or the low level monitoring operating system of the cloud server system automatically downloads the file or the new software or the patch to automatically execute the installation/uninstallation of the new software or the patch in background to detect whether the new software or the patch will be installed in the operating system. In a void, the present disclosure does not limit the implementation details of step S102.

Then, at step S103, the computing device or the low level monitoring operating system of the cloud server system determines whether an environment test should be executed. If that the environment test should be executed is determined, step S104 is then executed; if that the environment test cloud not be executed is determined, step S112 is then executed. The computing device or the low level monitoring operating system of the cloud server system judges whether the user or the MIS engineer agrees the execution of the environment test to determine whether the environment test should be executed; or alternatively, the computing device or the low level monitoring operating system of the cloud server system judges whether the current environmental resource is suitable for executing the environment test to determine whether the environment lest should be executed. However, the environment test comprises at least one of a system and software vulnerability test, a compatibility test, and an efficiency test. By the way, the system and software vulnerability test can be implemented by a fuzzing test for example, but the present disclosure is not limited thereto. In a word, the present disclosure does not limit the implementation details of step S103.

Next, at step S104, after determined to execute the environment test, the computing device or the low level monitoring operating system of the cloud server system selects the newest system and software information to execute the environment test by pre-setting; or alternatively, further selects the system and software information required by the user or the MIS engineer before agreeing the execution of the environment test to determine whether the environment test should be executed, step S105 is then executed. In a word, the present disclosure does not limit the implementation details of step S104.

Next, at step S105, the computing device or the low level monitoring operating system of the cloud server system generates a virtual machine with a clone environment according to the system and software information. To put it concretely, the computing device or the low level monitoring operating system of the cloud server system firstly generates a virtual machine with a clean operating system environment according to the operating system version and the operating system environment related configuration of the system and software information operating system, wherein the clean operating system environment is the clone environment which the virtual machine merely installs the initial operating system environment and the required application software, and does not have the redundant system setting and data generated by the user operation. Next, according to the application software version, the application software setting, and the operating system environment and application software patch installation list, the clean operating system can used to generate the operating system which the computing device or the virtual machine of the cloud server system currently uses. In other words, the clone environment of the virtual machine is functionally similar or equal to the operating system of the computing device or the virtual machine of the loud server system.

In addition, the above implementation of step S105 is not used to limit the present disclosure. Step S105 can be carried out by another implementation. For example, to reduce the time for generating the clone environment, the computing device or the low level monitoring operating system of the cloud server system may store a common use operating system environment generated in advance, and the common use operating system environment has common use software. Next, according to the system and software information, the computing device or the low level monitoring operating system of the cloud server system configures the common use operating system environment, adjusts settings of the common use software, and installs omitting software which have been installed in the operating system environment rather than the common use operating system environment in the common use operating system environment to generate the clone environment, so as to reappear the operating system of the computing device or the virtual machine of the cloud server system.

It is noted that, the pre-testing method for environment updating in fact uses a backup method costing little storage space. The steps S101, S104, and S105 can be form the backup method in the exemplary embodiment of the present disclosure. The backup method firstly extracts a system and software information of the operating system environment by using the parser. Essentially, the parser is operated to parse the predetermined particulars of the operating system environment such as the operating system version, the operating system serial code, the operating system environment related configuration, the application software version, the application software setting, and the operating system and application software patch installation list, so as to generate the system and software information (the system and software information such as an XML format). Then, generates a virtual machine with a clone environment according to the system and software information, wherein the clone environment substantially is the same as the operating system environment related to the predetermined particulars parsed from the system and software information.

Next, at step S106, the computing device or the low level monitoring operating system of the cloud server system obtains corresponding data of all data in the operating system to generate the virtual machine, and copy the corresponding data to the clone environment of the virtual machine, wherein the corresponding data is used for the environment test, i.e. the corresponding data is a subset of all data in the operating system environment, and is a portion of all data which is used for the environment test. It is noted that, to avoid that the corresponding data may be updated, the computing device or the low level monitoring operating system of the cloud server system obtains the corresponding data, and copy the corresponding data to the clone environment after the virtual machine with the clone environment is generated, such that the accuracy of the environment test can be guaranteed. Then, at step S107, the computing device or the low level monitoring operating system of the cloud server system installs the new software or the patch in the clone environment of the virtual machine. By the way, the backup method in the exemplary embodiment of the present disclosure can further comprises step S107, and the present disclosure is not limited thereto.

In the exemplary embodiment of the present disclosure, when the operating system environment or the software is initialized to install, the computing device or the low level monitoring operating system of the cloud server system takes a shot of the installation proceeding or installation configuration script to generate a corresponding script, and uses the script to generate the virtual machine with the clone environment. In another implementation, when the computing device or the low level monitoring operating system of the cloud server system uses the periodically backup system and software information of the operating system, the computing device or the low level monitoring operating system of the cloud server system generates the virtual machine with the clone environment. In another implementation, when the computing device or the low level monitoring operating system of the cloud server system backups the operating system according to the specific event (such as the behavior of removing/increasing a software or modifying application software setting) during operation, the computing device or the low level monitoring operating system of the cloud server system generates the virtual machine with the clone environment.

At step S108, the computing device or the low level monitoring operating system can use an active detection program to execute the environment test. The environment test comprises at least one of testing functions of the clone environment which has performed with the environment updating process (the environment test is not limited), comparing system states of the operating system environment and the clone environment which has performed with the environment updating process (the environment test is not limited), and comparing user experiences of the operating system and the clone environment which has performed with the environment updating process (the environment test is limited to be the compatibility test or efficiency test).

To put it concretely, the computing device or the low level monitoring operating system of the cloud server system can execute startup, close, input/output value detections (such as the behavior which the web program executes the database querying) of the specific related software of the clone environment which has performed with the environment updating process, so as to test the functions of the clone environment which has performed with the environment updating process. In another implementation, while the operating system environment and the clone environment which has performed with the environment updating process are operated, the computing device or the low level monitoring operating system of the cloud server system extract pieces of information (such as the software error message or the memory content) of the operating system environment and the clone environment which has performed with the environment updating process, and compares the extracted pieces of information, so as to compare system states of the operating system environment and the clone environment which has performed with the environment updating process. In another implementation, the computing device or the low level monitoring operating system of the cloud server system continuously switches the operating system environment and the clone environment which has performed with the environment updating process, and detects whether at least one of the user state and behavior (such as the user is disable to write down data in the specific column, and usually opens a specific window, or alternatively, the delay time which the operation command executed between the two systems exists) is changed when an user or a system software operates between the two system, so as to compare the user experiences of operating system environment and the clone environment which has performed with the environment updating process.

Then, at step S109, the computing device or the low level monitoring operating system of the cloud server system reports the result of the environment test to the user or the MIS engineer, such as a human machine interface is provided to report the system compatibility state, program flaw, information security, or error correcting suggest. It is noted that step S109 can be removed in the exemplary embodiment of the present disclosure, i.e. the result of the environment test is not reported to the user or the MIS engineer optionally.

Next, at step S110, the computing device or the low level monitoring operating system of the cloud server system determines whether the environment updating process can be performed to the operating system environment, or the low level monitoring operating system determines whether a new operating system environment (i.e. the clone environment which has performed with the environment updating process) can be switched to be used. If that the environment updating process can be to the operating system environment is determined, or that the new operating system environment can be switched to be used is determined, step S111 is then executed; if that the environment updating process cannot be to the operating system environment is determined, and that the new operating system environment cannot switched to be used is determined, step S112 is then executed. The computing device or the low level monitoring operating system of the cloud server system can automatically determines whether the environment updating process can be performed according to the result of environment test; or alternatively, the user or the MIS engineer can input command to the computing device or the low level monitoring operating system of the cloud server system according to the result of environment test, so as to indicate whether the computing device or the low level monitoring operating system of the cloud server system can perform the environment updating process.

At step S111, the computing device or the low level monitoring operating system performs the environment updating process to the operating system environment of the computing device or the virtual machine of the cloud server system, or alternatively, the cloud server system switches the virtual machine with the operating system environment to the virtual machine with the new operating system environment (i.e. the clone environment which has performed the environment updating process). Then, at step S112, the computing device or the low level monitoring operating system of the cloud server system records the update result. The computing device or the low level monitoring operating system of the cloud server system has the different update result according to different condition.

At step S113 the computing device or the low level monitoring operating system of the cloud server system provides a corresponding notification according to the update result. It is noted that, the existence of step S113 is not used to limit the present disclosure (i.e. step S113 can be removed). For example, the computing device or the low level monitoring operating system of the cloud server system can automatically schedules the next update checking time without notifying the user or the MIS engineer.

To put it concretely, if the operating system environment does not need to perform the environment updating process, or that the environment test should not be executed is determined, the update result record that the update or installation is not executed, and the operating system environment or the low level monitoring operating system can periodically notifies the user or the MIS engineer to execute the environment test and perform the environment updating process. If the environment updating process is performed, or the new operating system environment is switched to be used after the environment test is executed, the update result records which the environment updating process has been performed, and the operating system environment or the low level monitoring operating system notifies the user or the MIS engineer the message that the environment updating process has been performed. If the environment updating process is not performed, and the new operating system environment is not switched to be used after the environment test is executed, the update result records which the environment updating process has been detected, and the operating system environment or the low level monitoring operating system notifies the user or the MIS engineer whether the environment updating can be executed.

It is noted that, since the pre-testing method for environment updating can pre-test the environment updating before the environment updating process is performed, the system snapshot is not used to backup the whole operating system environment and the installed software in the operating system environment, and merely the system and software information is extracted. Thus, compared to the system snapshot, the pre-testing method for environment updating can reduce the consumption of the storage space from several ten Giga-bytes to several Mega-bytes. It is worth to note that the clone environment of the virtual machine is also can be used to recover the operating system environment without any testing. Furthermore, the execution order of each step in FIG. 1 is not used to limit the present disclosure. In another exemplary embodiment, the execution order of each step in FIG. 1 can be adjusted slightly. For example, regardless of the corresponding data is newest, steps S105 and S106 can be exchanged, or alternatively, steps S106 and S107 can be exchanged, i e. the corresponding data is obtained to the clone environment after the environment updating process is performed in the clone environment of the virtual machine.

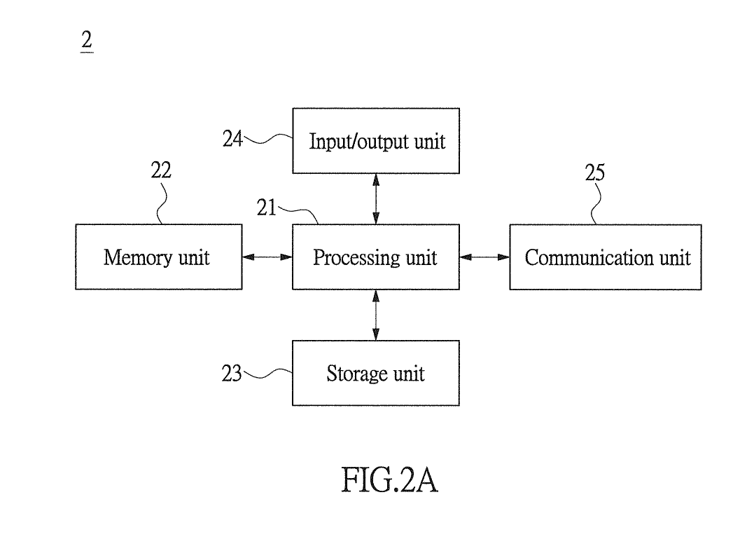

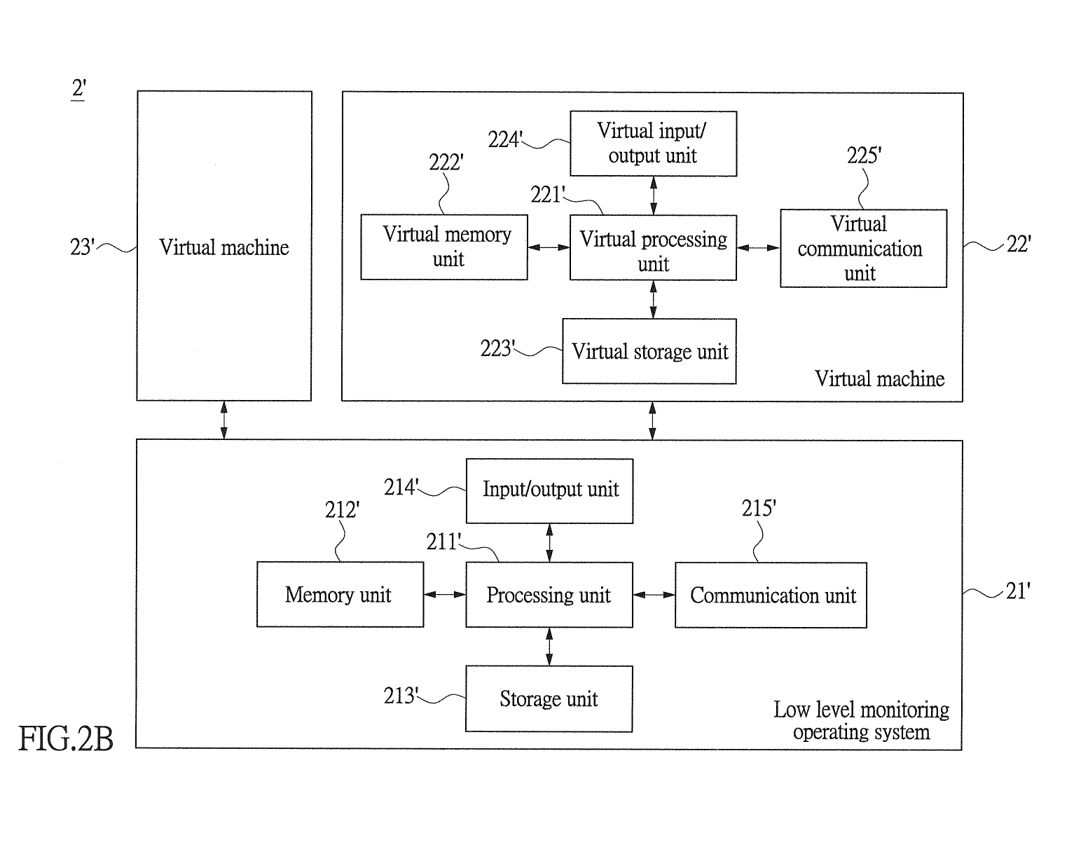

The pre-testing method is executed in the pre-testing system for environment updating, and as mentioned above, the pre-testing system can be implemented merely by the computing device or the cloud server system, or alternatively implemented by the system formed by the computing device and the cloud server system. Referring to FIG. 2A, FIG. 2A is a block diagram of a computing device according to an exemplary embodiment of the present disclosure. The computing device 2 comprises a processing unit 21, a memory unit 22, a storage unit 23, an input/output unit 24, and a communication unit 25. The processing unit 21 is electrically connected to the memory unit 22, the storage unit 23, the input/output unit 24, and the communication unit 25. The processing unit 21 is used to access the data in the memory unit 22 and the storage unit 23, and to control the input/output unit 24 and the communication unit 25.

In the exemplary embodiment, the codes of the pre-testing method for environment updating, the extracted system and software information, and the data related to the installed software or operating system environment can be stored in the storage unit 23. The memory unit 22 is used to temporally store the data or values generated by the processing unit 21. The input/output unit 24 is an interface between the computing device 2 and the user or the MIS engineer. The communication unit 25 makes the computing device 2 linked to the other computing device or the cloud server system.

Referring to FIG. 2B, FIG. 2B is a block diagram of a cloud server system according to an exemplary embodiment of the present disclosure. The cloud server system 2′ has a low level monitoring operating system 21′ and at least two virtual machines 22′, 23′. It is noted that, the virtual machines 22′, 23′, and the low level monitoring operating system 21′ are not physically linked to each other, and the low level monitoring operating system 21′ allocates resources to generate the virtual machines 22′, 23′.

The low level monitoring operating system 21′ has a processing unit 211′, a memory unit 212′, a storage unit 213′, an input/output unit 214′, and a communication unit 215′. The processing unit 211′ is electrically connected to the memory unit 212′ the storage unit 213′, the input/output unit 214′, and the communication unit 215′. The processing unit 211′ is used to access the data in the memory unit 212′ and the storage unit 213′, and control the input/output unit 214′ and the communication unit 215′.

The codes of the pre-testing method for environment updating and the data related to the installed software or operating system environment can be stored in the storage unit 213′. The memory unit 212′ is used to temporally store the data or values generated by the processing unit 211′. The input/output unit 214′ is an interface between the low level monitoring operating system 21′ and the user or the MIS engineer. The communication unit 215′ makes the low level monitoring operating system 21′ linked to the other computing device or the cloud server system.

According to requirements of the generate the virtual machines 22′ and 23′, the low level monitoring operating system 21′ allocates the resources of the processing unit 211′, the memory unit 212′, the storage unit 213′, the input/output unit 214′, and the communication unit 215′, so generate the virtual machines 22′ and 23′. The virtual machines 22′ and 23 respectively comprise independent or different operating systems (such as Microsoft Window, Linux, Mac OSX, and Google Android, and the present disclosure is not limited thereto). In addition, the virtual machines 22′ and 23′ have independent virtual processing unit, virtual storage units, virtual memory units, virtual input/output units, and virtual communication units.

For example, the virtual machine 22′ has a virtual processing unit 221′, a virtual memory unit 222′, a virtual storage unit 223′, a virtual input/output unit 224′, and a virtual communication unit 225′, wherein the virtual processing unit 221′ is logically connected (not physically connected) to the virtual memory unit 222′, the virtual storage unit 223′, the virtual input/output unit 224′, and the virtual communication unit 225′. The virtual processing unit 221′ is used to access the data in the virtual memory unit 222′ and the virtual storage unit 223′, and control the virtual input/output unit 224′ and the virtual communication unit 225′.

The codes of the pre-testing method for environment updating and the data related to the installed software or operating system can be stored in the virtual storage unit 223′. The virtual memory unit 222′ is used to temporally store the data or values generated by the processing unit 221′. The virtual input/output unit 224′ is an interface between the virtual machine 22′ and the user or the MIS engineer. The virtual communication unit 225′ makes the virtual machine 22′ linked to the other computing device or the cloud server system.

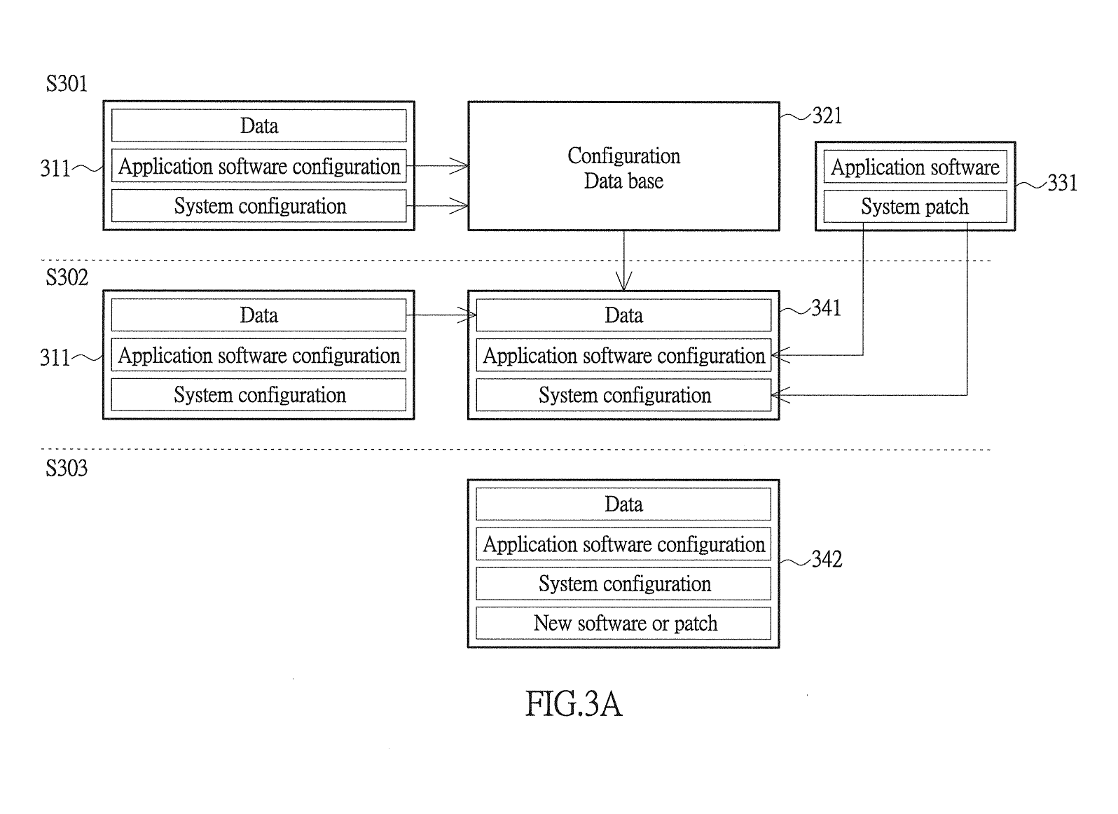

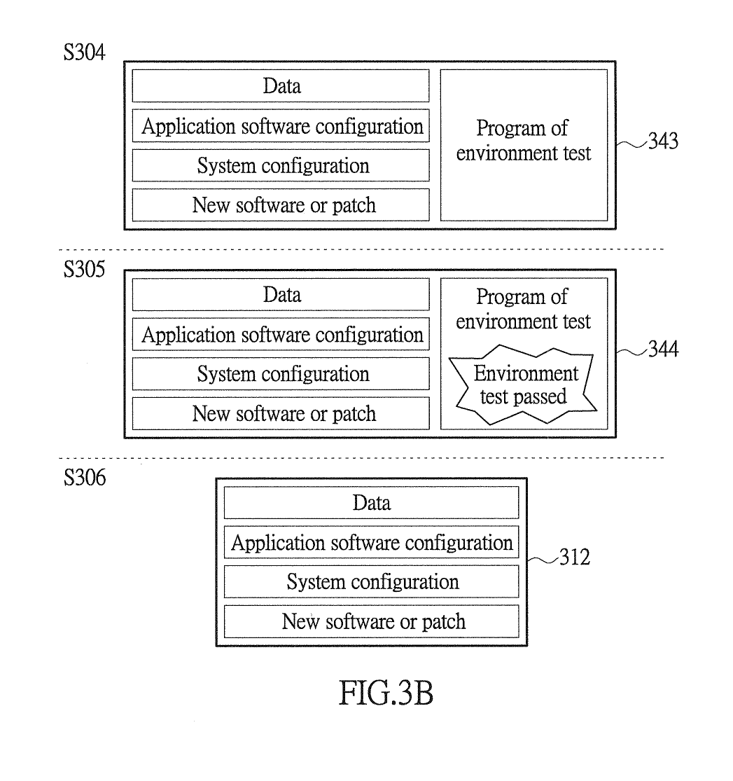

Referring to FIG. 3A and FIG. 3B, FIG. 3A and FIG. 3B are schematic diagrams of a pre-testing method for environment updating according to an exemplary embodiment of the present disclosure. In the exemplary embodiment, the software compatibility pre-testing system can be consisted of merely one computing device, but the present disclosure is not mited thereto. The operating system environment 311 of the computing device has data, application software configuration, and system configuration stored in the storage unit of the computing device. The storage unit has a configuration database 321 and a resource pool 331, wherein the configuration database 321 is used to store at least one system configuration, and the resources pool 331 stores the installation files of the application softwares and patches of the operating systems or the softwares.

At step S301, the computing device extracts the application software configuration and the system configuration (i.e. the system and software information) of the operating system environment 311 to the configuration database 321. When the user or the MIS engineer uses the user interface to check the state of the updated system environment, or the operating system automatically checks software compatibility, step S302 is then executed. At step S302, a virtual machine with a clone environment 341 is generated, wherein the clone environment 341 is functionally similar or equal to the operating system environment 311. The details of step S302 are illustrated. Firstly, the computing device generates a virtual machine with a clean operating system therein according to the system configuration of the configuration database 321. Next, by using the automatic installation program, the related application softwares and the patches of the softwares or the operating system are installed in the clean operating system environment to generate a clone environment, then according to the application software configuration and the system configuration, the clone environment is configured, and the settings of the softwares are adjusted. Next, the computing device obtains the corresponding data from the operating system environment 311 to the clone environment, so as to generate a clone environment 341 which is functionally similar or equal to the operating system environment 311.

Next, at step S303, the new software or the patch is installed in the clone environment 341, to generate a clone environment 342 which has performed the environment updating process. At step S304, the program of the environment test is introduced in the virtual machine having the clone environment 342 to generate a clone environment 343, herein the program of the environment test is a script which is used to execute startup, close, input/output value detections of specific related software in the clone environment 342. For example, if the number which the specific related softwares successfully startups, closes, or has the correct input/output values is larger than a specific threshold, the new software or the patch passes the environment test. At step S305, through the human machine interface, the computing device reports the system environment state, program flaw, security information and the error correction. At step S305, after the environment test of the clone environment 343 is executed, a clone environment 344 is generated, wherein the clone environment 344 has the system environment state being presented that the performed the environment updating process has passed the environment test. Then, at step S306, the user or the MIS engineer uses the user interface to confirm the execution for performing the environment updating process in the operating system environment 311, and thus the operating system environment 311 becomes an operating system environment 312 which has performed the environment updating process.

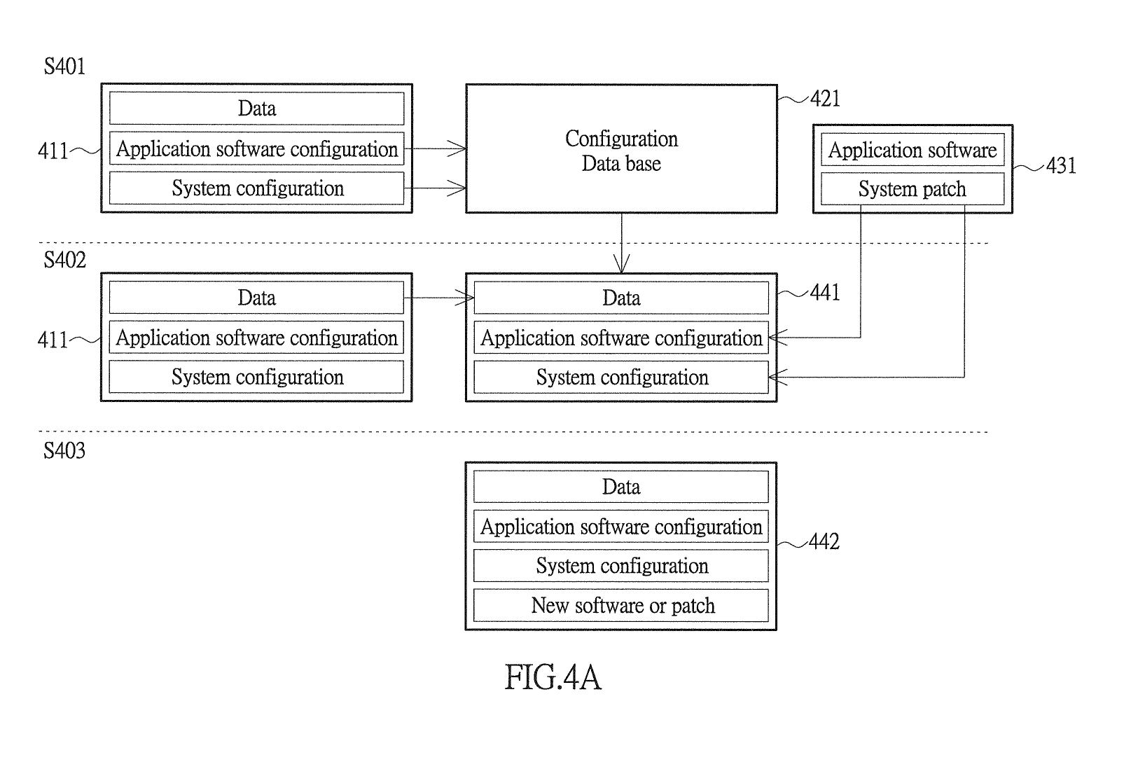

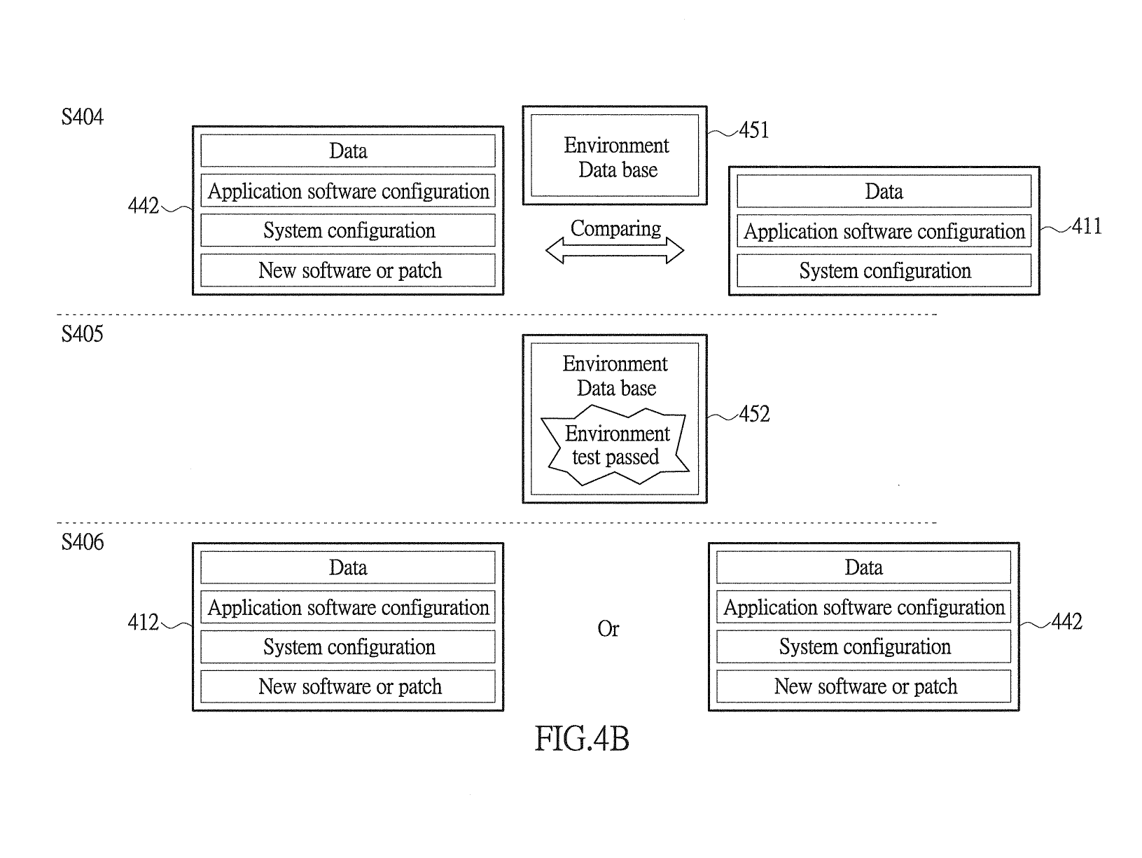

Next, referring to FIG. 4A and FIG. 4B, FIG. 4A and FIG. 4B are schematic diagrams of a pre-testing method for environment updating according to another exemplary embodiment of the present disclosure. In the exemplary embodiment, the software compatibility pre-testing system can be consisted of merely one cloud server system, but the present disclosure is not limited thereto. The operating system environment 411 operated in the virtual machine of the cloud server system has data application software configuration, and system configuration stored in the storage unit of the cloud server system. In addition, the storage unit has configuration database 421 and a resource pool 431, wherein the configuration database 421 is used to storage at least one system configuration, and the resources pool 431 stores the installation files of the application softwares and patches of the operating systems or the softwares.

At step S401, the cloud server system extracts the application software configuration and the system configuration (i.e. the system and software information) of the operating system environment 411 of the virtual machine to the configuration database 421. When the user or the MIS engineer uses the user interface to check the state of the updated system environment, or the operating system automatically checks software compatibility, step S402 is then executed. At step S402, a virtual machine having a clone environment 441 is generated, wherein the clone environment 441 is functionally similar or equal to the operating system environment 411. The details of step S402 are illustrated. Firstly, the cloud server system generates a virtual machine having a clean operating system therein according to the system configuration of the configuration database 421. Then, by using the automatic installation program, the related application softwares and the patches of the softwares or the operating system are installed in the clean operating system to generate a clone environment, then according to the application software configuration and the system configuration, the clone environment is configured, and the settings of the softwares are adjusted. Next the cloud server system obtains the corresponding data from the operating system environment 411 of the virtual machine therein to the clone environment, so as to generate a clone environment 441 which is functionally similar or equal to the operating system environment 411.

Next, at step S403, the new software or the patch is installed in the clone environment 441, to generate a clone environment 442 which has performed the environment updating process. At step 404, the program of the environment test in the low level monitoring operating system 451 of the cloud server system is executed to extract and compare pieces of information (such as software error message or the memory content) of the operating system environment 411 and the clone environment 442 while the operating system environment 411 and the clone environment 442 are operated, continuously switch the operating system environment 411 and the clone environment 422, and detect whether an user state or behavior is changed when an user o a system software operates between the operating system environment 411 and the clone environment 422 (such as the user is disable to write do n data in the specific column, and usually opens a specific window, or alternatively, the delay time which the operation command executed between the two systems exists). Since at step S404, the operating system environment 411 and the clone environment 442 need to be switched, the program of the environment test is stored in the low level monitoring operating system 451 of the cloud server, and executed by the low level monitoring operating system 451.

For example, the number which the extracted pieces of information of, the two systems are the same is larger than a specific threshold, or/and the user state or behavior changes slightly, the new software and the patch passes the environment test. The above illustration is just for one exemplary example, and the application scope, using manner, steps, or step execution order of the present disclosure is not limit thereto. At step S405, after the program of the environment test is executed, the a low level monitoring operating system 452 of the cloud server system is generated, wherein the low level monitoring operating system 452 has the system environment state being presented that the installed new software or patch has passed the environment test. Then, at step S406, the user or the MIS engineer uses the user interface to confirm the execution for performing the environment updating process in the operating system environment 411 of the virtual machine, and thus the operating system environment 411 becomes an operating system 412 hick has installed the new software or the patch; or alternatively, the user or the MIS engineer uses the user interface to confirm the execution for replacing the operating system environment 411 with the operating system 442, and copying the other data (except for the corresponding data for the compatibility test) in operating system environment 411 of the virtual machine to the clone environment 442.

It is noted that, step S404 can merely extract and compare information (such as software error message or the memory content) of the operating system environment 411 and the clone environment 442 while the operating system environment 411 and the clone environment 442 are operated; or alternatively, step S404 can merely continuously switch the operating system environment 411 and the second clone environment 422, and detect whether an user state or behavior is changed when an user or a system software operates between the operating system environment 411 and the clone environment 422.

If step S404 merely extracts and compares information of the operating system environment 411 and the clone environment 442 while the operating system environment 411 and the clone environment 442 are operated (i.e. does not switch the operating system environment 411 and the clone environment 442), the program of the environment test can be introduced in the clone environment 442 of the virtual machine, and executed by the clone environment 442. Next, at step S405, the clone environment 442 having the system environment state being presented that the new software or the patch passes the environment test is generated.

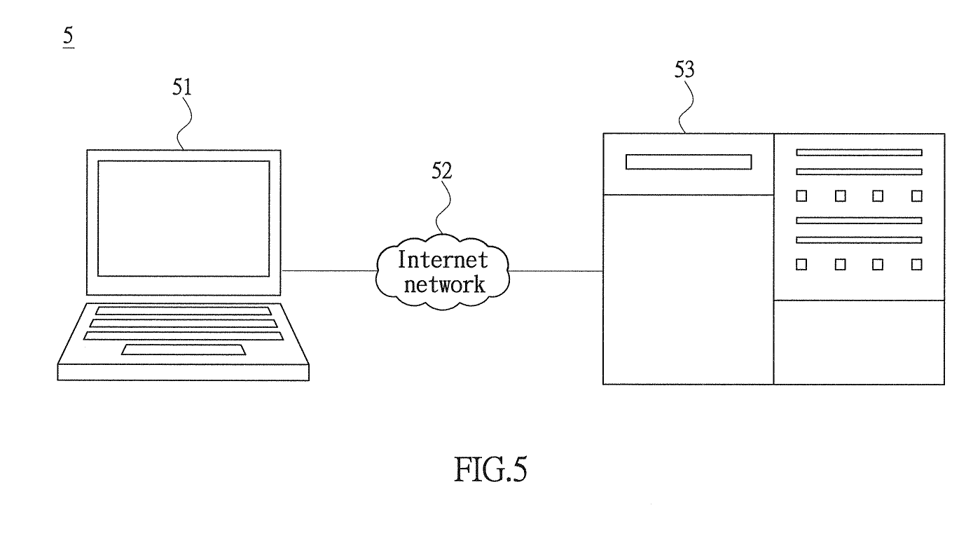

Referring to FIG. 5, FIG. 5 is a schematic diagram of a software compatibility pre-testing system according to an exemplary embodiment of the present disclosure. In the exemplary embodiment, the environment updating pre-testing system 5 comprises a computing device 51 and a cloud server system 53, wherein the computing device 51 is linked to the cloud server system 53 through the internet network 52. The user can use the cloud server system 53 through the computing device 51, or directly operate the cloud server system 53. The cloud server system 53 can have the administration right, so as to control the computing device 51 to update the software or the operating system patch. However, the present disclosure is not limited thereto, and in another implementation, the computing device 51 has the administration right itself.

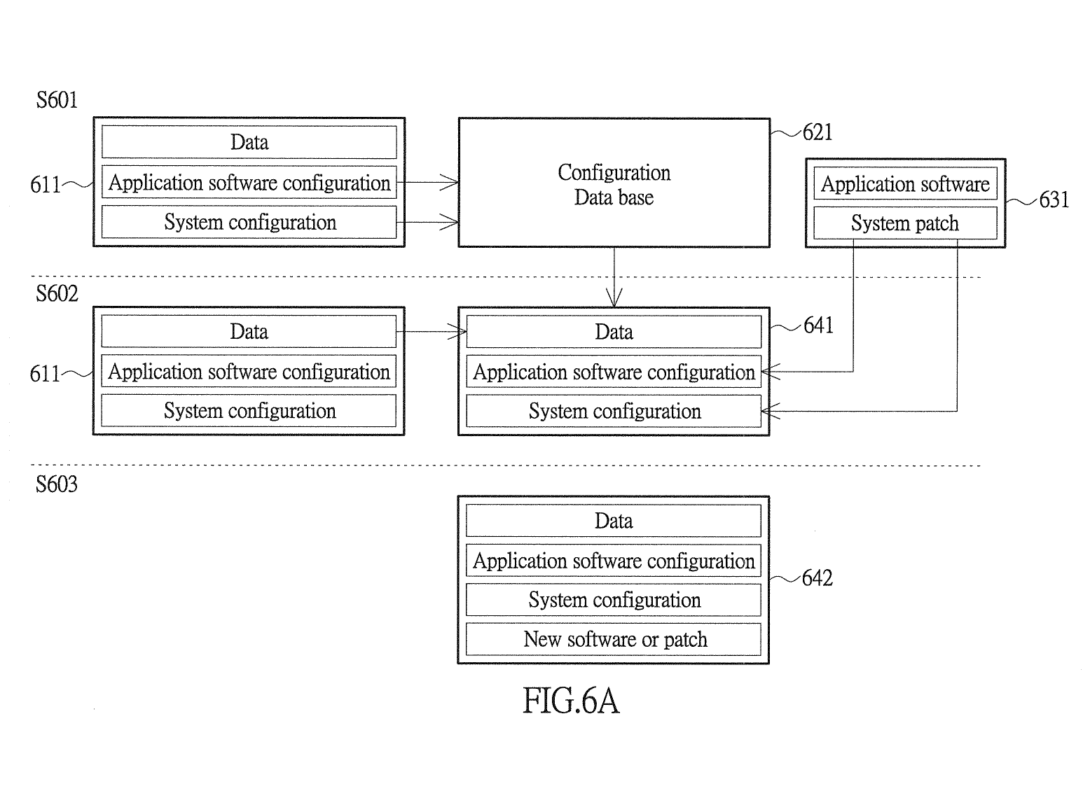

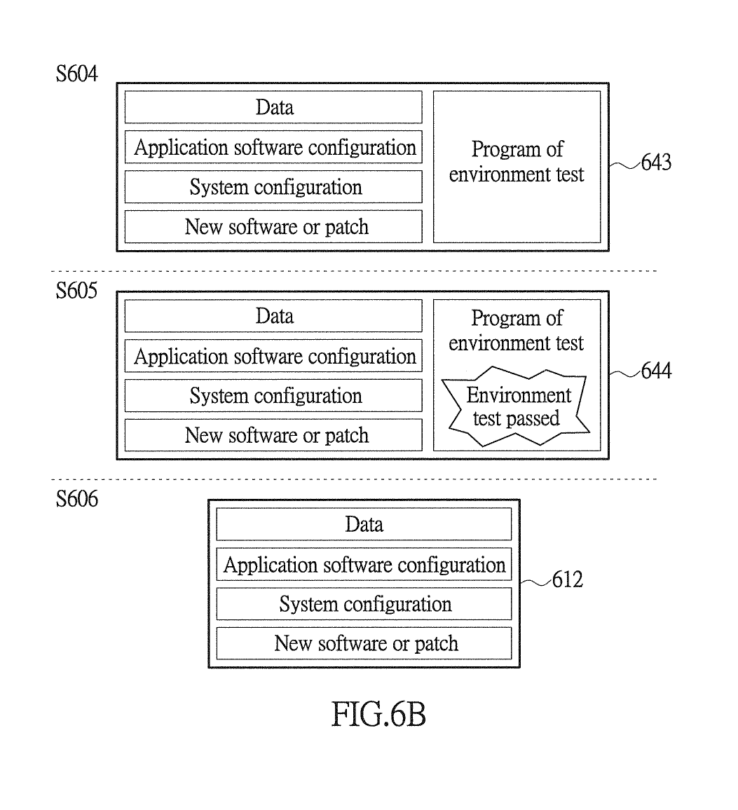

Referring to FIG.6A and FIG. 6B, FIG. 6A and FIG. 6B are schematic diagrams of a pre-testing method for environment updating according to another exemplary embodiment of the present disclosure. In the exemplary embodiment, the software compatibility pre-testing system comprises a computing device and a cloud server system. The operating system environment 611 of the computing device has data, application software configuration, and system configuration stored in the storage unit of the computing device. In addition, the storage unit of cloud server system has a configuration database 621 and a resource pool 631, wherein the configuration database 621 is used to storage at least one system configuration, and the resources pool 631 stores the installation files of the application softwares and patches of the operating systems or the softwares.

At step S601, the computing device extracts the application software configuration and the system configuration (i.e. the system and software information) of the operating system environment 611 to the configuration database 621 of the cloud server system. When the user or the MIS engineer uses the user interface to check the state of the updated system environment (can be determined by the computing device, or the cloud server system), or the operating system automatically checks software compatibility, step S602 is then executed. At step S602, a virtual machine having a clone environment 641 in the cloud server system is generated, wherein the clone environment 641 is functionally similar or equal to the operating system environment 611. The details of step S602 are illustrated. Firstly, the cloud server system generates a virtual machine with a clean operating system therein according to the system configuration of the configuration database 621. Then, by using the automatic installation program, the related application softwares and the patches of the softwares or the operating system are installed in the clean operating system to generate a clone environment, then according to the application software configuration and the system configuration, the clone environment is configured, and the settings of the softwares are adjusted. Next, the cloud server system obtains the corresponding data from the operating system environment 611 of the computing device to the clone environment, so as to generate a clone environment 641 which is functionally similar or equal to the operating system environment 611.

Next, at step S603, the new software or the patch is installed in the clone environment 641, to generate a clone environment 642 which has performed the environment updating process. At step S604, the program of the environment test is introduced in the virtual machine having the clone environment 642 to generate a clone environment 643, wherein the program of the environment test is used to is executed to extract and compare pieces of information (such as software error message or the memory content) of the operating system environment 611 and the clone environment 642 while the operating system environment 611 and the clone environment 642 are operated, and the program of the environment test may further executes startup, close, input/output value detections of specific related software in the clone environment 642. For example, if the number which the extracted pieces of information of the two systems are the same is larger than a specific threshold, and the number which the specific related softwares successfully startups, closes, or has the correct input/output values is larger than another specific threshold, the new software or the patch passes the environment test. At step S605, after the compatibility test of the clone environment 643 is executed, a clone environment 644 is generated, wherein the clone environment 644 has the system environment state being presented that the installed new software or patch has passed the environment test. Then, at step S606, the user or the MIS engineer uses the user interface to confirm the execution for performed the environment updating process in the operating system environment 611 (executed by the computing device), and thus the operating system environment 611 becomes an operating system 612 which has installed the new software or the patch.

To sum up, exemplary embodiments of the present disclosure provide a pre-testing method for environment updating and a system thereof, wherein the compatibility of the new software or the patch for the current operating system environment is pre-tested before the new software or the patch is installed in the operating system environment, such that the nuisance for recovering the operating system environment and the serious loss caused by that the operating system cannot be recovered can be avoided after the incompatible problem, program flaw, security information, or error correction occurs. Furthermore, the patch reliance for the user can be increased, so as to enhance the information security and avoid the attack by the hacker via the program flaw. Moreover, the pre-testing method for environment updating and a system thereof do not cause exhaustive storage space consumption, and can be carried out simply, therefore having beneficial economy result. Furthermore, the pre-testing method and system for environment updating use a backup method which costs little storage space. The backup method in an exemplary embodiment of the present disclosure merely stores the system and software information of the operating system environment rather than the system image of the whole operating system environment.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A pre-testing method adapted for environment updating, comprising:
while detecting that an environment updating process should be performed to an operating system environment, determining whether an environment test should be executed;
while detecting that the environment test should be executed, selecting a plurality of pieces of system and software information of the operating system environment, wherein the system and software information of the operating system environment is extracted from the operating system environment;
generating a virtual machine having a first clone environment according to the system and software information;
performing the environment updating process to the first clone environment of the virtual machine so as to cause the first clone environment to become a second clone environment of the virtual machine; and
executing the environment test for the second clone environment.

2. The pre-testing method adapted for environment updating according to claim 1, wherein before the step for selecting the system and software information of the operating system environment, the operating system environment is extracted periodically to generate the system and software information; or the operating system environment is extracted by an operating command to generate the system and software information.

3. The pre-testing method adapted for environment updating according to claim 1, further comprising:
according to a result of the environment test, determining whether the operating system environment can be performed with the environment updating process, and then performing the environment updating process to the operating system environment.

4. The pre-testing method adapted for environment updating according to claim 1, further comprising:
according to a result of the environment test, determining whether the second clone environment can be switched to be used, and then switching the second clone environment to be used.

5. The pre-testing method adapted for environment updating according to claim 1, wherein the environment updating process comprises at least one of installing a patch, installing new software, or uninstalling installed software.

6. The pre-testing method adapted for environment updating according to claim 1, wherein when determining that the environment test should be executed, obtaining corresponding data of all data in the operating system environment to generate the virtual machine, wherein the corresponding data is used for the environment test, and the first clone environment is generated according to the system and software information and the corresponding data.

7. The pre-testing method adapted for environment updating according to claim 1, wherein in the step for generating the first clone environment, generating a third clone environment according to the system and software information in the virtual machine, then, installing installed softwares and installed patches of the operating system environment in the third clone environment so as to cause the third clone environment to become a fourth clone environment, and obtaining the corresponding data for the fourth clone environment to generate the first clone environment, wherein the third clone environment is a clean operating system environment.

8. The pre-testing method adapted for environment updating according to claim 1, wherein in the step for generating the first clone environment, obtaining a common use operating system environment which is generated in advance, and the common use operating system environment has common use software, then, according to the system and software information, configuring the common use operating system environment, adjusting settings of the common use software, and installing omitting software which have been installed in the operating system environment rather than the common use operating system environment in the common use operating system environment to generate the first clone environment.

9. The pre-testing method adapted for environment updating according to claim 1, wherein the system and software information comprises at least one of an operating system version, an operating system serial code, an operating system environment related configuration, an application software version, an application software setting, and an operating system and application software patch installation list.

10. The pre-testing method adapted for environment updating according to claim 1, wherein the environment test comprises at least one of testing functions of the second clone environment, comparing system states of the second clone environment and the operating system environment, and comparing user experiences of the second clone environment and the operating environment.

11. The pre-testing method adapted for environment updating according to claim 10, wherein the environment test comprises at least one of a system and software vulnerability test, a compatibility test, and an efficiency test.

12. The pre-testing method adapted for environment updating according to claim 11, wherein the system and software vulnerability test is implemented by a fuzzing test.

13. The pre-testing method adapted for environment updating according to claim 10, wherein executing startup, close, input/output value detections of specific elated software in the second clone environment to test the functions of the second clone environment.

14. The pre-testing method adapted for environment updating according to claim 10, wherein extracting information of the operating system environment and the second clone environment while the operating system environment and the second clone environment are operated, and comparing the information to compare the system states of the second clone environment with the operating system environment.

15. The pre-testing method adapted for environment updating according to claim 10, wherein continuously switching the operating system environment and the second clone environment, and detecting whether an user state or behavior is changed when an user or a system software operates between the operating system environment and the second clone environment, so as to compare the user experiences of the second clone environment and the operating system environment.

16. A pre-testing system adapted for environment updating, comprising:
a computing device;
wherein while detecting that an environment updating process should be performed to an operating system environment, the computing device determines whether an environment test should be executed; while detecting that the environment test should be executed, the computing device selects a plurality of pieces of system and software information of the operating system environment, wherein the system and software information of the operating system environment is extracted from the operating system environment; the computing device generates a virtual machine having a first clone environment according to the system and software information; the computing device performs the environment updating process to the first clone environment of the virtual machine so as to cause the first clone environment to become a second clone environment of the virtual machine; the computing device executes the environment test for the second clone environment; and according to a result of the environment test, the computing device determines whether the operating system environment can be performed with the environment updating process.

17. The pre-testing system adapted for environment updating according to claim 16, wherein when that the environment test should be executed is determined, the computing device obtains corresponding data of all data in the operating system to generate the virtual machine, wherein the corresponding data is used for the environment test, and the first clone environment is generated according to the system and software information and the corresponding data.

18. A pre-testing system adapted for environment updating, comprising:
a cloud server system;
wherein while detecting that an environment updating process should be performed to an operating system environment, the cloud server system determines whether an environment test should be executed; while detecting that the environment test should be executed, the cloud server system selects a plurality of pieces of system and software information of the operating system environment operated in a first virtual machine of the cloud server system, wherein the system and software information of the operating system environment is extracted from the operating system environment; the cloud server system generates a second virtual machine having a first clone environment according to the system and software information; the cloud server system performs the environment updating process to the first clone environment of the second virtual machine so as to cause the first clone environment to become a second clone environment of the second virtual machine; and the cloud server system executes the environment test for the second clone environment.

19. The pre-testing system adapted for environment updating according to claim 18, wherein according to a result of the environment test, the cloud server system determines whether the operating system environment can be performed h the environment updating process.

20. The pre-testing system adapted for environment updating according to claim 18, wherein according to a result of the environment test, the cloud server system determines whether the second virtual machine having the second clone environment can be switched to be used.

21. The pre-testing system adapted for environment updating according to claim 18, wherein when determining that the environment test should be executed, the cloud server system obtains corresponding data of all data in the operating system environment to generate the second virtual machine, wherein the corresponding data is used for the environment test, and the first clone environment is generated according to the system and software information and the corresponding data.

22. A pre-testing system adapted for environment updating, comprising:
a computing device; and
a cloud server system, linked to the computing device through an internet network;
wherein while detecting that an environment updating process should be performed to an operating system environment, the computing device or the cloud server system determines whether an environment test should be executed; while detecting that the environment test should be executed, the computing device selects a plurality of pieces of system and software information of the operating system environment and transmits to the cloud server system, wherein the system and software information of the operating system environment is extracted from the operating system environment; the cloud server system generates a virtual machine having a first clone environment according to the system and software information; the cloud server system performs the environment updating process to the first clone environment so as to cause the first clone environment to become a second clone environment of the virtual machine; the cloud server system executes the environment test for the second clone environment; and according to a result of the environment test, the computing device determines whether the operating system environment can be performed with the environment updating process on the computing device.

23. The pre-testing system adapted for environment updating according to claim 22, wherein when determining that the environment test should be executed, the cloud server system obtains corresponding data of all data in the operating system environment to generate the second virtual machine, wherein the corresponding data is used for the environment test, and the first clone environment is generated according to the system and software information and the corresponding data.

24. A backup method, adapted to an operating system environment, comprising:
extracting a plurality of pieces of system and software information of the operating system environment; and
generating a virtual machine having a clone environment according to the system and software information;
wherein the clone environment substantially is the same as the operating system environment related to the extracted system and software information.
